(19) United States
(12) Patent Application Publication
(10) Pub. No.: US 2005/0039273 A1
(43) Pub. Date: Feb. 24, 2005

(54) Method and apparatus for depositing coating material on glass substrate

(75) Inventors: Joseph J. Hawley, Tukwila, WA (US); Michael W. Trout, Tukwila, WA (US)

Correspondence Address: KLARQUIST SPARKMAN, LLP, 121 SW SALMON STREET, SUITE 1600, PORTLAND, OR, 97204, US

(73) Assignee: Hartung Glass Industries

(21) Appl. No.: 10/916,057

(22) Filed: Aug. 9, 2004

Related U.S. Application Data
(60) Provisional application No. 60/496,331, filed on Aug. 18, 2003.

(51) Int. Cl. B41M 1/12

(52) U.S. Cl. 8/445

(57) ABSTRACT

An apparatus for applying a coating to a glass substrate that includes a flexographic printing element that includes a cylindrical surface having a circumference, wherein the cylindrical surface defines a continuous pattern that extends completely around the circumference of the cylindrical surface. Also disclosed are processes that include applying a coating material to a continuous pattern defined on a cylindrical surface of a rotating flexographic printing element.

This application claims the benefit of U.S. Provisional Application No. 60/496,331, filed Aug. 18, 2003, which is incorporated by reference herein.

### FIELD

The present disclosure relates to methods and apparatus for applying coating materials onto the surface of a glass substrate.

### BACKGROUND

Decorated flat glass is used in many applications. One example is architectural applications. For instance, it is used in skylights or windows to deflect direct sunlight, in showers to provide privacy, and many other similar applications where a pattern is desired.

A common method for decorating flat glass involves applying glass frit to the glass substrate via screen printing. Screen printing can make repetitive patterns (such as dots) or one of a kind patterns (such as pictures). In screen printing glass frit is squeezed through a fine mesh screen to create the pattern while the glass substrate is positioned directly under, and touching, the screen. The glass frit is transferred onto the glass by a squeegee pushing it through the screen. The screen is plugged or masked in areas where an image on the glass substrate is not desired. If a different pattern (size or design) is desired, the screen must be modified before the next impression.

In many cases, a large screen is made for repetitive patterns. The image on the screen is typically larger than the actual desired image on the glass substrate. This allows manufacturers to buy only one screen and use it for many different substrate sizes. For a pattern where the screen has an image that is bigger than the glass to be printed, each dimension of glass substrate (width or length) requires a modification to the screen. Usually, this requires masking the sides and/or ends where the screen size is larger than the glass substrate size. This masking material will not allow the frit to be pushed through the screen in a non-image area.

For large pieces of glass substrate, the requirement to have a large screen makes the equipment and the process expensive. In order to be capable of occasionally printing large pieces, the machine and the screen must be large, even though smaller pieces will routinely be printed. Even though the screen and machine are able to print large areas, some of this area is routinely masked to prevent frit from contaminating unwanted areas for smaller images. Each time a different size of glass substrate is desired for printing, the screen and process must be adjusted accordingly. These time-consuming set-up steps decrease the efficiency of the process. A method that eliminates or minimizes the need for numerous set-ups would be very useful.

### SUMMARY

Disclosed herein are apparatus and processes for applying a coating to a flat glass substrate. In one aspect, the apparatus includes a flexographic printing element that includes a cylindrical surface having a circumference, wherein the cylindrical surface defines a continuous pattern that extends completely around the circumference of the cylindrical surface. The apparatus further includes at least one roll proximal to the flexographic printing element such that a coating material can be transferred from the roll to the continuous pattern. A flat glass substrate transport assembly is configured to consecutively advance at least one first flat glass substrate having a first dimension and at least one second flat glass substrate having a second dimension into contact with the continuous pattern, wherein the first dimension and the second dimension are different.

Also detailed herein is a process that includes applying a coating material to a continuous pattern defined on a cylindrical surface of a rotating flexographic printing element. At least one first flat glass substrate having a first dimension and at least one second flat glass substrate having a second dimension is advanced into contact with the continuous pattern, wherein the first dimension and the second dimension are different.

In another aspect, there is disclosed a continuous process that includes applying a glass frit to a continuous pattern defined on a cylindrical surface of a flexographic printing element, rotating the flexographic printing element, and advancing at least one flat glass substrate into contact with the continuous pattern defined on the cylindrical surface of the flexographic printing element. Due to the continuous pattern provided on the cylindrical surface, the leading edge of the flat glass substrate does not have to be registered with an initiating rotation position for the cylindrical surface of the flexographic printing element.

The foregoing and other features and advantages will become more apparent from the following detailed description of several examples, which proceeds with reference to the accompanying figures.

### BRIEF DESCRIPTION OF THE FIGURES

FIG. 1 is an elevation view of an example of a presently disclosed apparatus.

FIG. 2 is a plan view of the apparatus shown in FIG. 1 (with the apparatus in FIG. 1 being rotated 180°).

FIG. 3 is an elevation view of another example of the presently disclosed apparatus.

FIG. 4 is a plan view of the apparatus shown in FIG. 3.

FIG. 5 is a cross-sectional view of an ink delivery embodiment.

In the figures, like reference numerals refer to like elements unless indicated otherwise.

### DETAILED DESCRIPTION OF SEVERAL EXAMPLES

For ease of understanding, the following terms used herein are described below in more detail:

“Continuous pattern” refers to an image or pattern formed on the cylindrical surface of the flexographic printing element that seamlessly extends around the complete circumference of the cylindrical surface as described below in more detail. A continuous pattern embraces anything capable of modifying the appearance and/or structure of the glass substrate, whether by imparting to it a particular effect; by lending it an ornamental appearance; or by providing it with other functions. The image or pattern may be a decorative design or picture, or a pattern designed to impart functional characteristics to the surface of the glass substrate. The pattern may also be a planar coating that at least substantially covers a desired surface area of the glass substrate.

“Glass frit” refers to a composition that includes at least one glass powder. “Glass frit” is inclusive of enamels and glazes if they include a glass powder.

The above term descriptions are provided solely to aid the reader, and should not be construed to have a scope less than that understood by a person of ordinary skill in the art or as limiting the scope of the appended claims.

The singular terms “a,” “an,” and “the” include plural referents unless context clearly indicates otherwise. Similarly, the word “or” is intended to include “and” unless the context clearly indicates otherwise.

Printing of a glass substrate or sheet of varying width or length can be accomplished by the presently disclosed apparatus and processes without the need to interrupt the process to change the printing element. The continuous pattern defined on the flexographic plate can be printed repetitively onto varying sizes of glass substrates. Only the glass substrate surface that contacts the pattern on the flexographic plate will receive the coating material meaning that it is unnecessary to mask areas that will not be printed.

Consequently, the size of the glass substrate is no longer of paramount importance for establishing the initial set-up of the apparatus and process. Setting-up the apparatus by inserting a different size of printing element or adjusting the masked portion of the printing surface is no longer required for each different size of glass substrate. Once a flexographic printing element with the desired image is installed, the apparatus can process any glass substrate size without requiring another set-up of the apparatus. For example, a very wide piece of glass can be printed and then a very narrow piece of glass can be printed on the same line without having to stop the line to change the configuration of the printing element.

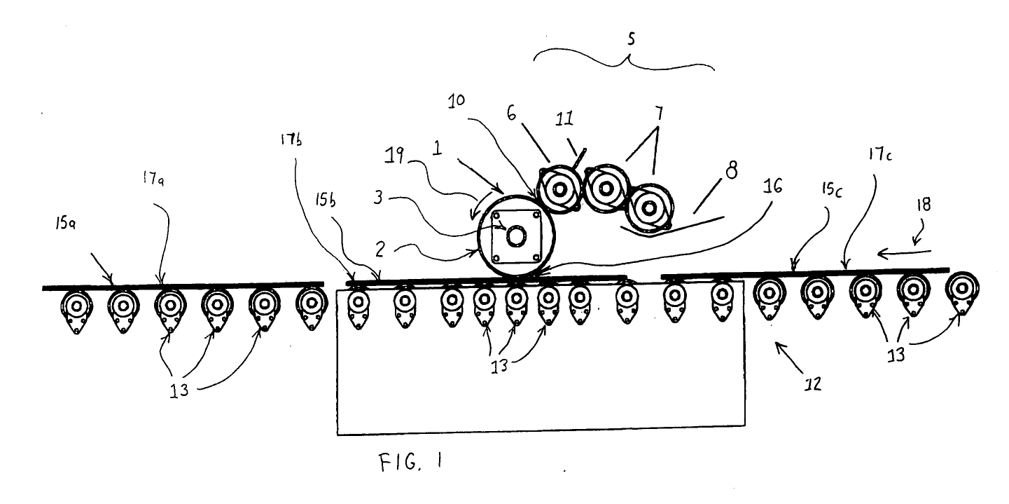

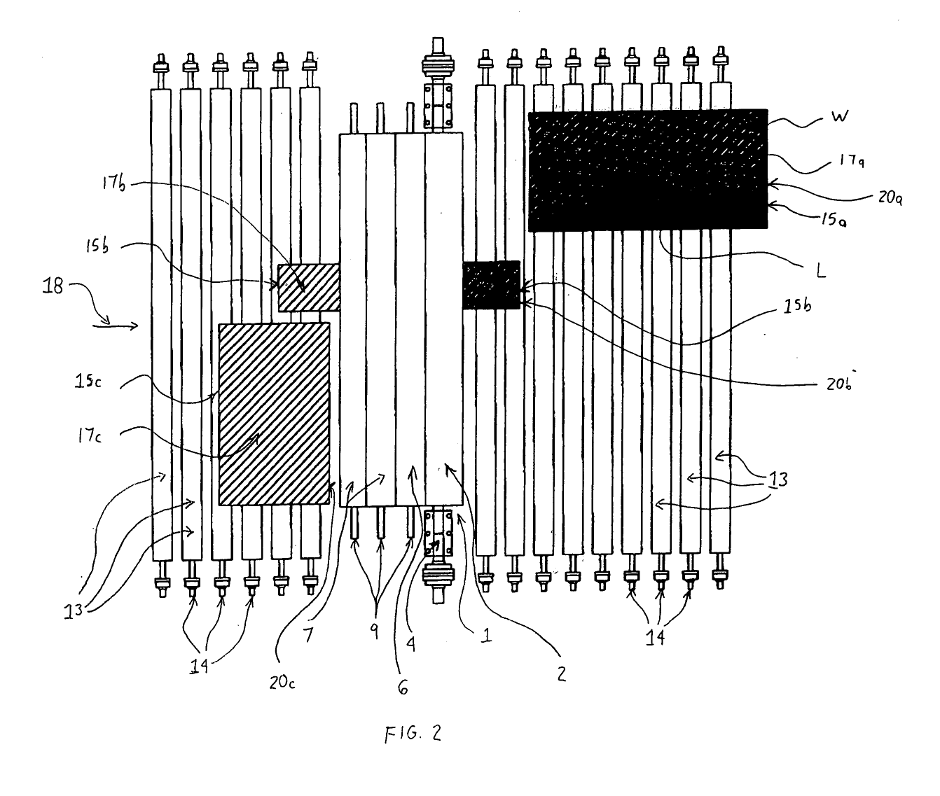

With reference to FIGS. 1 and 2, one example of a printing apparatus is described in detail. A flexographic roll assembly 1 is provided that includes a continuous flexographic plate 2 disposed on a mandrel 3. The mandrel 3 is supported along its longitudinal axis by a rotatable shaft 4. The continuous flexographic plate 2 usually is in the shape of a cylinder having an outer circumferential surface. The cylindrical continuous flexographic plate 2 may be mounted onto the mandrel 3 by methods known in the art such as, for example, via adhesives. The size of the outer circumference of the flexographic roll assembly 1 is not critical. As a general example, the outer circumference of the flexographic roll assembly 1 is designed to coincide with conventional repeat lengths of flat glass substrates which may range, for instance, from about 2 inches to about 50 or 60 inches. Although only a single flexographic roll assembly is depicted in FIGS. 1 and 2, it is possible to have more than one flexographic roll assembly on a single processing line. For example, there may be two flexographic roll assemblies provided in series along the process flow direction or there may be provided two flexographic roll assemblies provided in parallel with another across the width of the apparatus (i.e., transverse to the process flow direction).

The continuous flexographic plate 2 typically is a resilient relief plate made of elastomeric material, such as natural rubber, synthetic rubber or other synthetic elastomers, an elastomeric photopolymer, or similar materials. The outer circumferential surface of the continuous flexographic plate 2 exhibits a raised surface that defines the desired continuous pattern. The continuous pattern extends around the entire outer circumference of the cylindrical flexographic plate 2. The raised surface carries the coating material to the surface of the glass substrate. One approach for obtaining the raised surface involves providing a photopolymer on the surface of the flexographic plate, and then masking, radiation-exposing, and etching the photopolymer as appropriate for obtaining the pattern.

A coating material transfer assembly 5 is located in a proximal position relative to the flexographic roll assembly 1. The coating material transfer assembly 5 can be a single roll or a series of rolls configured to transfer the coating material onto the outer circumferential surface of the continuous flexographic plate 2. In the specific option depicted in FIGS. 1 and 2 the coating material transfer assembly 5 includes an anilox roll 6, two transfer rolls 7, and a coating material source 8. The coating material source 8 may be a well, a drum or a similar container capable of holding a coating material. The anilox roll 6 and the two transfer rolls 7 are each supported along -their longitudinal axis, respectively, by rotatable support shafts 9. The anilox roll 6 and the transfer rolls 7 may have any outer circumference that is sufficient for transferring the desired amount of coating material. The support shafts 9 for the coating material transfer assembly 5 are arranged parallel to the support shaft 4 for the mandrel 3.

A coating material transfer nip 10 is located where the outer circumferential surface of the anilox roll 6 engages with the outer circumferential surface of the continuous flexographic plate 2. The coating material present on the outer circumferential surface of the anilox roll 6 is transferred at the nip 10 to the outer circumferential surface of the continuous flexographic plate 2. Similarly, the two transfer rolls 7 are engageably juxtaposed between the anilox roll 6 and the coating material container 8 so as to transfer the coating material from the container 8 to the anilox roll 6.

A doctor blade or doctor roller 11 contacts the outer circumferential surface of the anilox roll 6. The doctor 11 scrapes the coating material present on the outer circumferential surface of the anilox roll 6 so as to substantially evenly distribute a measured amount of the coating material across the outer circumferential surface. The doctor 11 may be supported by structure (not shown) that can regulate the pressure at which the blade of the doctor 11 is pressed against the outer circumferential surface of the anilox roll 6.

Positioned underneath the flexographic roll assembly 1 is a glass substrate transport system 12. The glass substrate transport system 12 includes a series of successive conveyor rolls 13. Each conveyor roll is supported along its longitudinal axis by a respective rotatable support shaft 14. The support shafts 14 for the conveyor rolls are arranged substantially parallel to the support shafts 9 for the coating material transfer assembly 5 and the support shaft 4 for the flexographic roll assembly 1. The conveyor rolls 13 together form a moveable platform for advancing glass substrates 15a, 15b, and 15c. A conveyor belt system may be employed as an alternative to the conveyor rolls.

Each of the glass substrates has an upper surface 17a, 17b, and 17c, respectively. A coating nip 16 is located where an upper surface 17b of the glass substrate 15b engages with the raised continuous image defined on the outer circumferential surface of the continuous flexographic plate 2. The mandrel 3 and/or the rotatable shaft 4 may be biased (e.g., with a spring) so that substrates of varying thicknesses can be processed through the coating nip 16. Alternatively, the width of the coating nip 16 may be adjusted by mechanically adjusting the position of the flexographic roll assembly 1 relative to the glass substrate transport system 12.

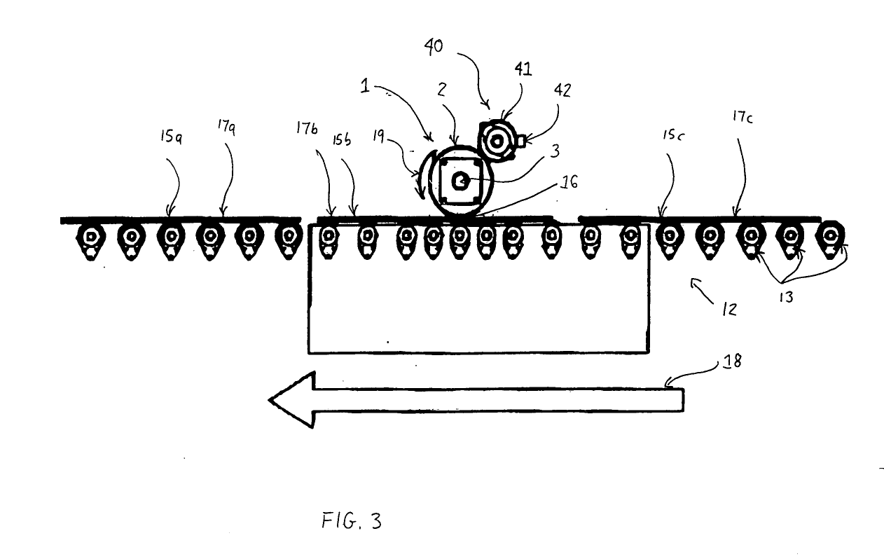

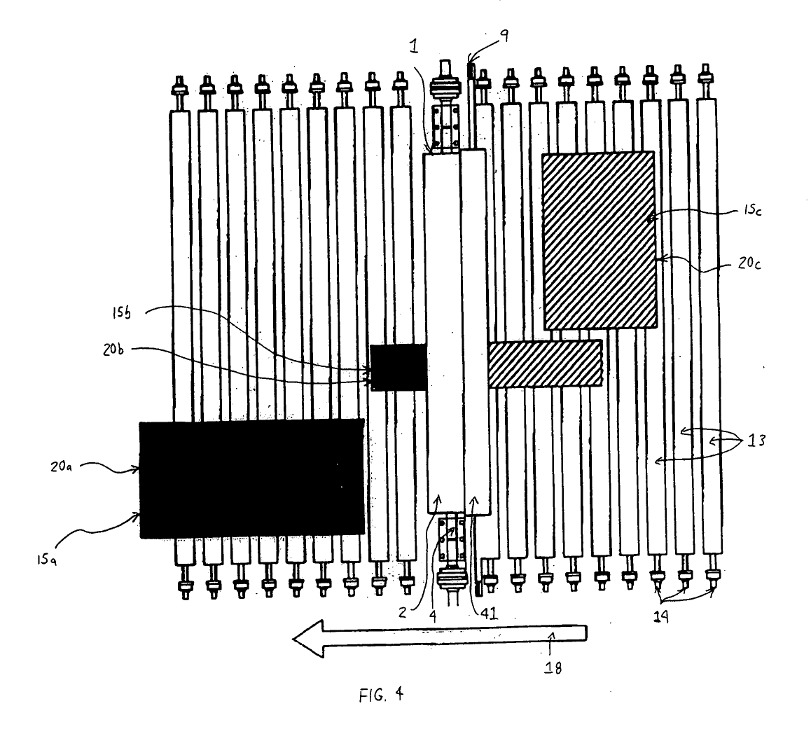

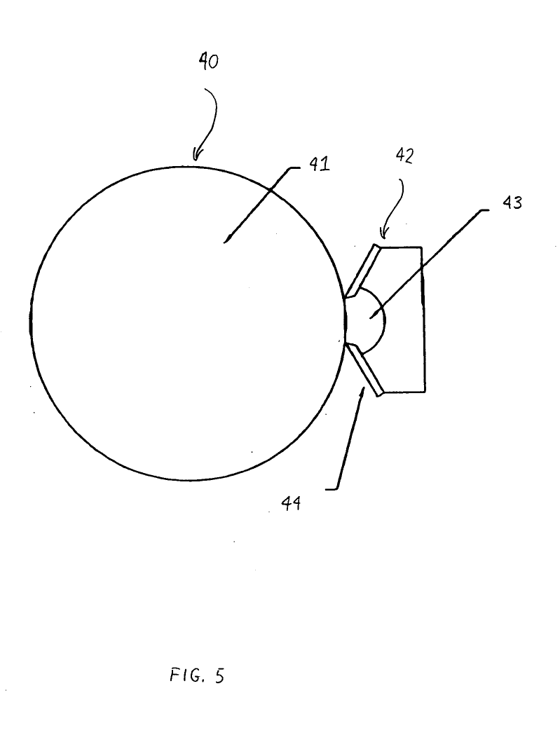

A further embodiment of a printing apparatus is depicted in FIGS. 3 and 4. In this embodiment, there is provided a coating material transfer assembly 40 that differs from the coating material transfer assembly 5 shown in FIG. 1. The coating material transfer assembly 40 is depicted in more detail in FIG. 5. The coating material transfer assembly 40 includes an anilox roll 41 and a self-inking doctor blade assembly 42. The self-inking doctor blade assembly 42 includes an integral ink or media chamber 43 and two doctor blades 44. The doctor blades 44 and side seals (not shown) form a seal against the anilox roll 41 to be inked.

An example of a coating method disclosed herein is described below with reference to the apparatus shown in FIGS. 1 and 2. A series of glass substrates 15a, 15b, and 15c are successively introduced onto the conveyor rolls 13. Each glass substrate 15a, 15b, and 15c has a leading edge 20a, 20b, and 20c, respectively. It is apparent from FIG. 2 that each of the glass substrates 15a, 15b, and 15c have different length (designated by L) and width dimensions (designated by W) relative to each other. Of course, a first batch of a plurality of substrates having a first width and a first length may be processed followed by a second batch of a plurality of substrates having a second width and a second length. The glass substrates 15a, 15b, and 15c are advanced via the conveyor rolls 13 in the process flow or machine direction as indicated by direction arrow 18. As shown in FIG. 2, glass substrate 15c has not yet been coated, the upper surface 17b of glass substrate 15b has been partially coated, and the upper surface 17a of glass substrate 15a has been substantially coated.

The coating material transfer assembly rolls rotate to transfer coating material from the coating material container 8 to the continuous pattern defined on the continuous flexographic plate 2. As a glass substrate passes through the coating nip 16, the flexographic roll assembly 2 rotates in the direction of rotation arrow 19. The coating material present on the raised surface of the continuous pattern is coated onto the upper surface of the glass substrate at the coating nip 16. Typically, the amount of pressure or downward force existing at the coating nip 16 is insufficient to embed the coating material into the glass substrate. In other words, the coating material is deposited onto the glass substrate via contact rather than through the application of additional pressure. The coating of the glass substrate typically is performed at ambient room or atmospheric conditions. However, if desired, the coating can be performed under higher than room temperature conditions by heating the ambient atmosphere in the near vicinity of the coating nip 16, providing a mechanism for heating the continuous flexographic plate 2, and/or heating the glass substrate.

The surface speed of the rotating continuous flexographic plate 2 is adjusted by a motor or similar control device (not shown) to match the transport speed of the glass substrate on the conveyor rolls 13. The repetitive rotation of the continuous image defined on the continuous flexographic plate 2 means that the plate 2 can rotate as much as necessary to complete the pattern on the glass substrate. In other words, each incremental distance that the continuous flexographic plate 2 rotates equates to a pattern-printing of the same incremental distance on the glass substrate. For instance, if the continuous flexographic plate 2 has an outer circumference of one foot and a first glass substrate has a length of three feet, then the continuous flexographic plate 2 undergoes three complete revolutions to complete the pattern on the first glass substrate. The next successive glass substrate (referred to herein as the “second substrate”) has a length of six inches. The continuous flexographic plate 2 then only undergoes a one-half revolution to impart the pattern onto the second glass substrate. Such continuous printing on different substrates with different dimensions can be performed continuously without having to re-configure the process such as by changing the size of the printing element or adjusting the process line speed (i.e., the rotational speed of the continuous flexographic plate 2 or the transport speed of the glass substrate). Moreover, since the continuous pattern is continuous around the entire circumference of the continuous flexographic plate 2 there is no need to re-set the starting or initiating rotation position of the flexographic roll assembly 1 when the length and/or width of the incoming glass substrate changes.

As depicted in FIG. 2 the width of the flexographic roll assembly 1 may be sufficient to permit the simultaneous printing of more than one glass substrate if the combined width of the glass substrates is less than the width of the flexographic roll assembly 1. In this instance, the two glass substrates (e.g., 15a and 15b) can be positioned adjacent to each other in a transverse direction relative to process flow direction 18.

The coated glass substrate (e.g., substrate 15a) can undergo further processing as necessary to form a finished coating. For example, the coating material as applied to the glass substrate may be wet or dry. In the case of glass frit, the glass frit typically is wet as applied to the glass substrate. The glass frit then undergoes drying either by the ambient atmosphere or by passing the glass frit-coated substrate through a furnace. Subsequently, the glass frit-coated substrate is heat treated (sometimes referred to as “firing”) to vitrify or sinter the glass frit into the flat glass substrate. This heat treatment may be accomplished by passing the glass frit-coated glass substrate through a furnace at a temperature of about 300 to about 725° C.

The thickness of the coating applied to the glass substrate is not critical in the context of the present disclosure. The thickness depends upon a number of factors including the intended use of the coating, the type of coating material, and the type of glass substrate. As a general example, the coating thickness may range from about 0.005 to about 0.02 or 0.03 inches.

In general, any type of coating material capable of being used with flexographic printing can be employed. The applied coating may be decorative and/or functional. In one aspect, the coating material is used to impart a decorative image onto the surface of the flat glass substrate. Glass frit, enamel (which often contain glass frit), and glazes (which often contain glass frit) are several examples of possible decorative coatings. In another aspect, functional coatings that may be applied include, for example, hydrophilic coatings, hydrophobic coatings, energy-saving coatings, or reflective coatings.

The coating material may be an aqueous or non-aqueous, multi-ingredient solution, dispersion or emulsion. The coating material may include a radiation-curable component such as a UV-, ambient light-, or electron beam-curable polymer. The coating material may include pre-polymerized film-forming polymers or polymerizable monomer, oligomers or polymers such as those described above. Other examples of film-forming polymers include poly(vinyl alcohol)s, poly(methyl methacrylate)s, polystyrenes, polyesters, polyamides, polyethylene glycols, polyimides, polycarbonates, epoxies, and polyacrylonitriles. Various additives may be included such as a surfactant, an emulsifier, a solvent, a mar resistant agent, a hardening agent, a coalescing agent, a plasticizing agent, a defoaming agent, and a release agent.

In one example, a glass frit is applied to the flat glass substrate. Glass frit compositions include vitrifiable glass powders made from glasses such as boroaluminosilicate, borosilicate, lead silicate, zinc silicate, zinc borosilicate, phosphate silicate, and bismuth borosilicate. Glass frit compositions may also include pigments; crystallization-promoters such as zircon, alumina or a glass ceramic; a carrier component such as water, a liquid polymer or pre-polymer, or a monomeric solvent; and an organic binder such as acrylic or cellulose resins.

The process disclosed herein may be used with any type of flat glass substrate. Examples of flat glass include glass-ceramic plate, float glass and slumped glass.

Having illustrated and described the principles of the disclosed apparatus and methods, it will be apparent that these apparatus and methods may be modified in arrangement and detail without departing from such principles.

1. An apparatus for applying a coating to a flat glass substrate, comprising:
a flexographic printing element that includes a cylindrical surface having a circumference, wherein the cylindrical surface defines a continuous pattern that extends completely around the circumference of the cylindrical surface of the flexographic printing element;
at least one roll proximal to the flexographic printing element such that a coating material can be transferred from the roll to the continuous pattern defined on the cylindrical surface of the flexographic printing element; and
a flat glass substrate transport assembly configured to consecutively advance at least one first flat glass substrate and at least one second flat glass substrate into contact with the continuous pattern defined on the cylindrical surface of the flexographic printing element, wherein the first flat glass substrate has a first width dimension and a first length dimension and the second flat glass substrate has a second width dimension and a second length dimension such that at least the first and second width or the first and second length dimensions are different.

2. The apparatus of claim 1, wherein the flexographic printing element comprises a cylindrical flexographic plate mounted onto a mandrel.

3. The apparatus of claim 1, wherein the roll proximal to the flexographic printing element comprises an anilox roll, and the apparatus further comprises at least one transfer roll that engages with the anilox roll and a source for the coating material.

4. An apparatus for applying a coating to a flat glass substrate, comprising:
a flexographic printing element that includes a cylindrical surface having a circumference, wherein the cylindrical surface defines a continuous pattern that extends completely around the circumference of the cylindrical surface of the flexographic printing element;
means for introducing a coating material onto the continuous pattern; and
means for contacting the continuous pattern defined on the cylindrical surface of the flexographic printing element with at least one first flat glass substrate having a first width and length dimension and at least one second flat glass substrate having a second width and length dimension.

5. A process for imparting a pattern to a flat glass plate, comprising:
applying a coating material to a continuous pattern defined on a cylindrical surface of a rotating flexographic printing element; and
advancing at least one first flat glass substrate having a first dimension and at least one second flat glass substrate having a second dimension into contact with the continuous pattern defined on the cylindrical surface of the flexographic printing element such that at least a portion of the continuous pattern is individually imparted onto each of the first flat glass substrate and the second flat glass substrate, wherein the first flat glass substrate has a first width dimension and a first length dimension and the second flat glass substrate has a second width dimension and a second length dimension such that at least the first and second width or the first and second length dimensions are different.

6. The process of claim 5, wherein the process comprises a continuous process that includes successively advancing the first flat glass substrate and the second flat glass substrate into contact with the continuous pattern.

7. The process of claim 5, wherein at least a portion of the first flat glass substrate and at least a portion of the second flat glass substrate are simultaneously contacted with the continuous pattern.

8. The process of claim 5, wherein the pattern substantially covers an upper surface of the first flat glass substrate and an upper surface of the second flat glass substrate.

9. The process of claim 6, wherein the flexographic printing element does not require re-configuration or re-setting between contacting the first flat glass substrate with the continuous pattern and contacting the second flat glass substrate with the continuous pattern.

10. A continuous process for applying a pattern to a flat glass substrate, comprising:
applying a glass frit to a continuous pattern defined on a cylindrical surface of a flexographic printing element;
advancing in a process flow direction at least one first flat glass substrate having a first dimension and a leading edge; and
rotating the cylindrical surface of the flexographic printing element so that the first flat glass substrate contacts the continuous pattern defined on the cylindrical surface of the flexographic printing element;
wherein the leading edge of the first flat glass substrate is not registered with an initiating rotation position for the cylindrical surface of the flexographic printing element.

11. The process of claim 10, further comprising processing the glass frit-coated first flat glass substrate under conditions sufficient for fixing the pattern to the first flat glass substrate.

12. The process of claim 10, further comprising advancing at least one second flat glass substrate having a second dimension into contact with the continuous pattern defined on the cylindrical surface of the flexographic printing element, wherein the first dimension is different than the second dimension.

13. The process of claim 12, wherein the first flat glass substrate has a first width dimension and a first length dimension and the second flat glass substrate has a second width dimension and a second length dimension such that at least the first and second width or the first and second length dimensions are different.

14. The apparatus of claim 1, wherein the roll proximal to the flexographic printing element comprises an anilox roll, and the apparatus further comprises a self-inking doctor blade assembly associated with the anilox roll.
